(19) United States
(12) Patent Application Publication
(10) Pub. No.: US 2004/0186400 A1
(43) Pub. Date: Sep. 23, 2004

(54) Therapeutic/ergonomic, hand-held massage knob

(76) Inventor: Sylvia Thomas, Baltimore, MD (US)

Correspondence Address: Royal W. Craig, Law Offices of Royal W. Craig, Suite 153, 10 N. Calvert Street, Baltimore, MD, 21202, US

(21) Appl. No.: 10/705,169

(22) Filed: Nov. 7, 2003

Related U.S. Application Data
(60) Provisional application No. 60/425,836, filed on Nov. 12, 2002.

(51) Int. Cl. A61H 7/00; A61H 15/00

(52) U.S. Cl. 601/135

(57) ABSTRACT

A hand-held massage knob incorporating a design that provides ergonomic benefits for the massage technician without compromising his/her ability to deliver an effective message is disclosed herein. The present invention generally comprises a coarse, granular material contained within a flexible bladder. The flexible bladder allows the shape of the present invention to be changed as required during the administration of a massage. The message knob may also be varied in size to accommodate a wide variety of technician hand sizes and client body sizes. The present invention is fabricated of materials providing the appropriate degree of durability/longevity required by the nature of its use, and its design is simple and straightforward allowing it to be economically manufactured and sold.

### CROSS-REFERENCE TO RELATED APPLICATIONS

The present application derives priority from U.S. Provisional Patent Application No. 60/425,836, filed 12 Nov. 2002.

### BACKGROUND OF THE INVENTION

1. Field of the invention

The present invention relates to the process of administering massage and, more specifically, to devices used during the administration of a massage which provide therapeutic and/or ergonomic benefits both to the technician administering the massage and the individual receiving the massage.

2. Description of the Background

The art of personal massage is intended to provide certain therapeutic benefits (e.g. stress reduction, relaxation of tense/tight muscles) to the individual receiving a massage (the “client”). However, the therapeutic benefits received by the client should not be at the expense of the health of the technician administering a message.

Professional administration of a massage requires the repeated application of significant pressure to various areas of the client's body via the hands of the massage technician. This type of repeated exertion places significant strain on the joints, muscles, and tendons of the technician's fingers and wrists, often resulting in the development of some form of repetitive motion injury (e.g. carpal tunnel syndrome). Once an injury of this type has developed, a massage technician is faced with two equally unpleasant choices, to continue to work and live with the constant pain of the injury or to stop working as a massage therapist in an effort to allow the injury to heal.

To the best of the knowledge of the present inventor, the prior art does not contain an apparatus specifically intended to avoid repetitive motion injuries to massage technicians, without compromising the beneficial nature of the process for the client. Currently available message-related apparatus include smooth, substantially flat stones (typically heated before application to the client) and devices comprising assemblies of rods and spheres or rolling surfaces. The stones are fixed in size and shape and, therefore, cannot conform to all parts of the body and can be difficult to take hold of during application/removal. The spherical/rolling devices, typically not utilized by professional massage technicians, are also fixed in size/shape and do not incorporate handles designed to avoid the occurrence of repetitive motion injury during extensive, prolonged use.

Therefore, it would be greatly advantageous to supply an apparatus that reduces a massage technician's probability of developing a repetitive motion injury without compromising the benefits received by the client. The apparatus must, from the perspective of the client, represent a satisfactory replacement for the hands of the professional technician with their inherent ability to conform and/or apply appropriate amounts of pressure to his/her body. From the perspective of the message technician, the apparatus must allow him/her to replicate the varying shape and movement of his/her hands while providing an ergonomically appropriate method for holding on to it. An apparatus of this type should also be fabricated of materials providing the appropriate degree of durability/longevity due to the nature of use, and be economical to manufacture and sell to provide for widespread utilization.

### SUMMARY OF THE INVENTION

It is, therefore, the primary object of the present invention to provide an improved hand-held massage tool possessing therapeutic and/or ergonomic benefits for the client as well as the technician administering a massage.

It is another object of the present invention to provide an improved hand-held massage tool that is ergonomically appropriate and simple to use.

It is still another object to provide an improved hand-held massage tool that reduces a massage technician's probability of developing a repetitive motion injury such as carpal tunnel syndrome.

Yet another object of the present invention is to provide an improved hand-held massage tool that is fabricated of materials providing the appropriate degree of durability/longevity.

Still another object of the present invention is to provide an improved hand-held massage tool that is economical to manufacture and sell.

These and other objects are accomplished by a hand-held massage knob incorporating a design that provides ergonomic benefits for the massage technician without compromising his/her ability to deliver an effective message (i.e. the therapeutic benefits to the client). The present invention generally comprises a coarse, granular material contained within a flexible bladder. The flexible bladder allows the shape of the present invention to be changed (i.e. conformed to different areas of the body) as required during the administration of a massage. The present invention may also be varied in size to accommodate a wide variety of technician hand sizes and client body sizes. The present invention is fabricated of materials providing the appropriate degree of durability/longevity required by the nature of its use, and its design is simple and straightforward allowing it to be economically manufactured and sold.

### BRIEF DESCRIPTION OF THE DRAWINGS

Other objects, features, and advantages of the present invention will become more apparent from the following detailed description of the preferred embodiment and certain modifications thereof when taken together with the accompanying drawings in which:

FIG. 1 is a side perspective view of a hand-held massage knob 10 according to a first embodiment of the present invention.

FIG. 2 is an end perspective view of the hand-held massage knob 10 of FIG. 1.

FIG. 3 is a cross-sectional view of the hand-held massage knob 10 of FIGS. 1 and 2.

### DETAILED DESCRIPTION OF THE PREFERRED EMBODIMENT

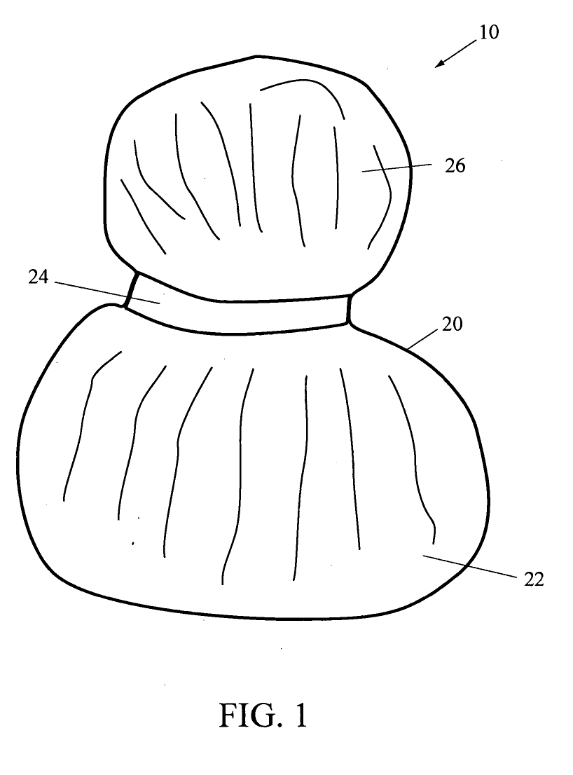

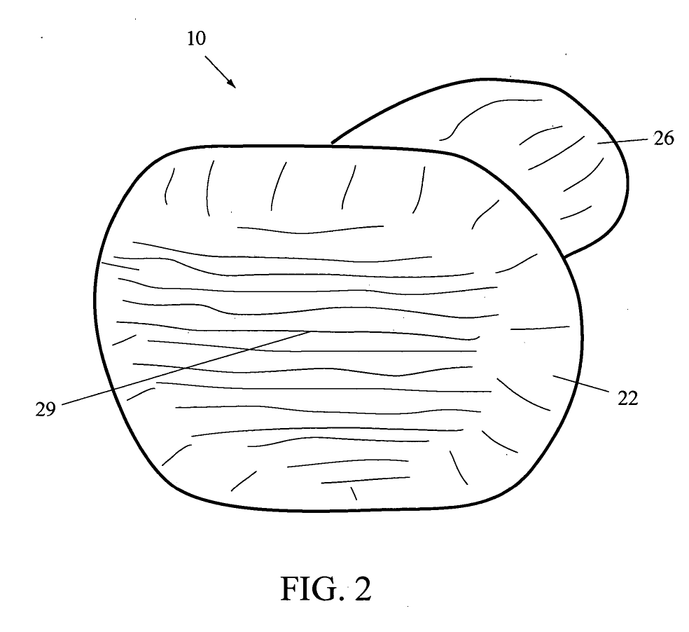

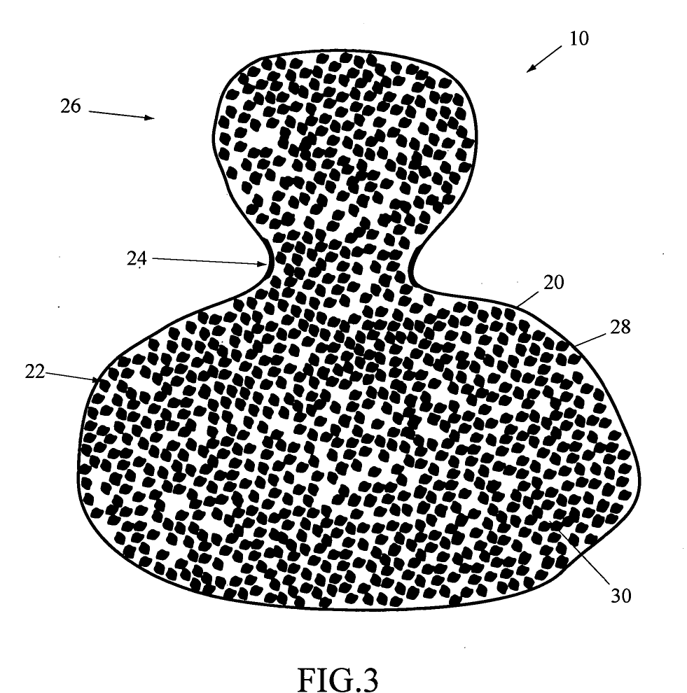

FIGS. 1 and 2, respectively, provide side and end perspective views of a hand-held massage knob 10 according to the present invention. FIG. 3 is a cross-sectional view of the message knob 10 as in FIGS. 1 and 2. The present invention generally comprises a coarse, granular material 30 contained within a contoured flexible bladder 20. The granular material 30 may be a common substance possessing a relatively small grain size such as sand. The bladder 20 may be fabricated (i.e. molded) from a commercially-available, rubber material such as silicone rubber. The thickness of the rubber material forming the bladder 20 must be sufficient to bear the weight of the granular material 30 contained within and to withstand, for a reasonable length of time, the frictional wear (i.e. abrasion) occurring along its inner surface due to the movement of that material 30, without compromising the flexibility and shape/surface adaptability of the overall massage knob 10.

The bladder 20 is formed to retain a particular shape, which is divided into a main cavity 22, a throat area 24, and a handle cavity 26. When not in use by a massage technician (i.e. being manipulated to conform to either the body of the client or the hand(s) of the technician see discussion below), the main cavity 22 and handle cavity 26 are best described as being substantially spherical in shape with each cavity 22, 26 truncated by the plane passing through, or defined by, the throat area 24. The volumetric ratio between the truncated, substantially spherical main cavity 22 and the truncated, substantially spherical handle cavity 26 is preferably within the range of approximately 1:1 to approximately 10:1. The outer surface 28 of the bladder 20 may be smooth or ribbed 29 (see FIG. 2) in the area of the main cavity 22 or the handle cavity 26 to enhance the therapeutic and/or ergonomic benefits of the overall massage knob 10. The main cavity 22 is designed to adapt to the contours of the body of the client. The handle cavity 26 serves as an ergonomic hand-hold by which a technician grasps and utilizes the message knob 10. The throat area 24 provides for a minimal amount of granular material 30 transfer between the main cavity 22 and the handle cavity 26.

The flexible bladder 20 allows the shape of the massage knob 10 to be manipulated (i.e. conformed to different areas of the body) as required during the administration of a massage. Both the main cavity 22 and the handle cavity 26 of the bladder 20 are scalable allowing for variation in size to accommodate a wide variety of technician hand sizes and client body sizes.

The granular material 30 consists of relatively small grains in order to maximize the ability of (1) the main cavity 22 to conform to the shape of the client's body and (2) the handle cavity 26 to provide an ergonomic hand-hold for the technician to grasp. Small grains also allow for some transfer of material 30 through the throat area 24, between the main and handle cavities 22, 26, respectively, to maximize the utility of the massage knob 10 during the administration of a massage.

In use, the technician grasps the handle cavity 26 of the massage knob 10 in order to apply varying amounts force to the body of the client via the outside surface of the main cavity 22. The shape of the handle cavity 26 and the main cavity 22 may be manipulated by the technician as required for the different steps/processes included in a typical massage.

The size and shape flexibility of the handle cavity 26 allows for extensive, long-term use by massage technicians without concern for the development of repetitive motion injuries. The ergonomic design of the handle cavity 26 also allows those technicians already suffering from some form of repetitive motion injury to continue working in their chosen profession without fear of exacerbating their condition. The size and shape flexibility of the main cavity 22 allows massage technicians to deliver levels of therapeutic benefits equivalent to those which are provided when their hands are used directly on the bodies of the clients.

As is readily perceived in the foregoing description, the present invention is fabricated of materials providing the appropriate degree of durability/longevity required by the nature of its use, and its design is simple and straightforward allowing it to be economically manufactured and sold.

Having now fully set forth the preferred embodiment and certain modifications of the concept underlying the present invention, various other embodiments as well as certain variations and modifications of the embodiments herein shown and described will obviously occur to those skilled in the art upon becoming familiar with said underlying concept. It is to be understood, therefore, that the invention may be practiced otherwise than as specifically set forth in the appended claims.

I claim:

1. A therapeutic/ergonomic hand-held massage knob, comprising:
a flexible bladder, said flexible bladder further comprising;
a substantially spherical main cavity;
a throat area fixedly attached to said main cavity; and
a substantially spherical handle cavity fixedly attached to said throat area; and
a coarse, granular substance contained within said main and handle cavities and said throat area of said flexible bladder;
whereby the shape of either of said cavities of said flexible bladder may be manipulated by a massage technician during the administration of a massage.

2. The therapeutic/ergonomic hand-held massage knob according to claim 1, wherein said flexible bladder is fabricated from a rubber material.

3. The therapeutic/ergonomic hand-held massage knob according to claim 2, wherein said rubber material is silicone rubber.

4. The therapeutic/ergonomic hand-held massage knob according to claim 1, wherein the outer surface of said main cavity is smooth.

5. The therapeutic/ergonomic hand-held massage knob according to claim 1, wherein the outer surface of said main cavity is textured.

6. The therapeutic/ergonomic hand-held massage knob according to claim 5, wherein said textured outer surface comprises a plurality of raised ribs.

7. The therapeutic/ergonomic hand-held massage knob according to claim 1, wherein the outer surface of said handle cavity is smooth.

8. The therapeutic/ergonomic hand-held massage knob according to claim 1, wherein the outer surface of said handle cavity is textured.

9. The therapeutic/ergonomic hand-held massage knob according to claim 8, wherein said textured outer surface comprises a plurality of raised ribs.

10. The therapeutic/ergonomic hand-held massage knob according to claim 1, wherein said coarse, granular substance possesses a relatively small grain size.

11. The therapeutic/ergonomic hand-held massage knob according to claim 10, wherein said coarse, granular substance is sand.

12. The therapeutic/ergonomic hand-held massage knob according to claim 1, wherein the volumetric ratio between said main cavity and said handle cavity is within the range of approximately 1:1 to approximately 10:1.

13. A method of administering a massage using one or more therapeutic/ergonomic hand-held massage knobs comprising the steps of;
grasping an ergonomic, substantially spherical handle cavity of said massage knob by a massage technician;
applying a substantially spherical main cavity of said massage knob to a recipient of said massage by said massage technician; and
manipulating the shape of said handle cavity and said main cavity by said massage technician, on an as-needed basis during the administration of said massage, to adapt the external contour of said main cavity to said recipient's body and thereby optimize the therapeutic effect of said massage, said shape manipulation being facilitated by transferring an amount of a coarse, granular substance contained within said handle cavity and said main cavity through a throat area connecting said cavities;
whereby said method results in the delivery of a therapeutic massage to said recipient while allowing said technician to minimize the potential for developing a repetitive motion syndrome injury.
